(19) United States
(12) Patent Application Publication
(10) Pub. No.: US 2008/0251656 A1
(43) Pub. Date: Oct. 16, 2008

(54) Support System

(75) Inventor: Ian James Prismall, Hungerford (GB)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Primac Limited, Berkshire (GB)

(21) Appl. No.: 12/099,379

(22) Filed: Apr. 8, 2008

(30) Foreign Application Priority Data
Apr. 12, 2007 (GB) 0707013.9

(51) Int. Cl. F16L 3/00; E04H 17/00; E04H 17/16

(52) U.S. Cl. 248/121; 256/65.01; 256/24

(57) ABSTRACT

A support system comprises a first component, a second component to be secured to the first component and to be supported, at least in part, thereby in use, and a coupling arrangement for securing the first and second components to one another, the coupling arrangement comprising a lock member secured to one of the first and second components by a crank, and a socket provided on the other of the first and second components and adapted to receive part of the lock member, wherein the lock member and the socket are designed such that the lock member can only be inserted into or removed from the socket when tilted or angled relative thereto.

This invention relates to a support system. Although one application of the invention is in the provision of a barrier, the support system being used to support, or form part, of the barrier, the invention is also suitable for use in a number of other applications including railings, storage systems, exhibition stands, supporting printed media, electrical or electronic display panels, signage and the like.

According to one aspect of the invention there is provided a support system comprising a first component, a second component to be secured to the first component and to be supported, at least in part, thereby in use, and a coupling arrangement for securing the first and second components to one another, the coupling arrangement comprising a lock member secured to one of the first and second components by a crank, and a socket provided on the other of the first and second components and adapted to receive part of the lock member.

With such an arrangement, with the lock member located in the socket, adjustment of the crank secures the first and second components to one another.

One of the first and second components may comprise a support, for example in the form of a post, and the other may comprise for example, a barrier or rail member. The barrier or rail member may be of rigid or generally rigid form.

Alternatively, one of the first and second components may comprise a barrier or rail member and the other may comprise a component arranged substantially perpendicularly thereto, for example, such that a pair of barrier or rail members and associated perpendicular components can together form a frame, for example of square or rectangular form. Although the frame alone may be used, the frame could be used to support, for example, sheets of printed media, display panels, signage, electrical or electronic display devices for example in the form of LCD screens, plasma screens or matrix type display devices.

In any of the arrangements described hereinbefore, the lock member and the socket may be designed such that the lock member can only be inserted into or removed from the socket when tilted or angled relative thereto. For example, the lock member may include a head intended to be received, in use, by the socket, the head having a width greater than a width of the socket so that, when angularly aligned with the socket the head cannot pass through part of the socket and so can be held captive thereby.

The invention also relates to a barrier or rail member, for example suitable for use in the support system described hereinbefore, the barrier or rail being provided along at least part of the length thereof with at least one elongate slot or groove of re-entrant shape. The slot is preferably of T-shaped cross-section, but could be of other forms. The slot may be adapted to receive and mount to the barrier or rail member a media support device. An illumination system, for example using LEDs provided adjacent an edge of the support device, may be provided. Other devices, for example display panels, signage, electrical or electronic display devices or the like may be supported by the elongate slot or groove.

According to another aspect of the invention, a post and/or barrier or rail member may be illuminated using illumination means. The illumination means may comprise, for example, internally located light emitting devices. Another possibility is for the post and/or barrier or rail member to be made up, at least in part, of a luminous material. It will be appreciated that a range of other illumination means are also possible.

The invention further relates to a coupling arrangement comprising a socket into which a lock member is insertable when tilted, the socket comprising a slot through which part of the lock member can be introduced, the said part of the lock member having a dimension greater than the corresponding dimension of the slot, and biasing means arranged to apply a lateral biasing load to the said part of the lock member, when located within the socket.

The provision of the biasing means resists movement of the lock member necessary in combination with tilting to allow the said part to pass through the slot. Accidental release of the coupling arrangement is thereby resisted. The biasing means could comprise, for example, a leaf spring. Preferably it comprises a resilient plastics element moulded integrally with at least part of the socket.

The coupling arrangement could be used in conjunction with a crank to form part of a coupling arrangement as described hereinbefore. Alternatively it may be used in other applications, for example in retractable barrier systems.

The invention also relates to a housing assembly for securing to a support comprising a plurality of connection elements each having a formation associated therewith to engage, in use, a corresponding formation associated with the support, a lower housing member adapted to overlie and cover part of each connection element to restrict outward movement thereof, and an upper housing member adapted to overlie and cover part of each connection element, the upper housing member preferably being snap-fitted to the connection elements to secure the connection elements and upper and lower housing members to one another and to the support.

The support could take a range of forms. For example it may comprise a tubular post or post section, an adapter to allow the housing assembly to be fitted to another component, for example a cone, or means for mounting the housing assembly to another structure.

An upper part of each connection element may be provided with a formation engageable with a second support, thereby enabling location of the housing assembly part-way along the length of, for example, a post. The housing assembly may define sockets suitable for use in any of the applications described hereinbefore. The housing assembly may, if desired, house a rotatable spool of a retractable barrier system. In such an arrangement, a modified connection element may be provided defining an opening through which a length of flexible barrier material may extend.

Any or all of the connection elements may be provided with a pocket or opening forming part of a socket suitable for use in any of the arrangements described hereinbefore. If desired, biasing means may be associated with the socket as described hereinbefore.

The invention also relates to a post provided with a screen which may take the form of an apertured sleeve mounted thereon, the position of the sleeve being adjustable to expose different parts of the post through the apertures of the sleeve. The apertures of the sleeve may be provided with transparent elements which may, if desired, incorporate lenses or the like. It will be appreciated that such an arrangement is advantageous in that two or more sets of images maybe provided upon a post, which set of images being visible depending upon the position occupied by the sleeve. For example angular movement may switch between a first set of images being displayed and a second set being displayed. Alternatively, a windowed post or post perforated by at least one aperture may be provided with movable internal signage or images to achieve substantially the same effect, characterised in that the display visible can be altered by changing the position of the screen relative to the underlying design or image.

The invention will further be described, by way of example with reference to the accompanying drawings, in which:

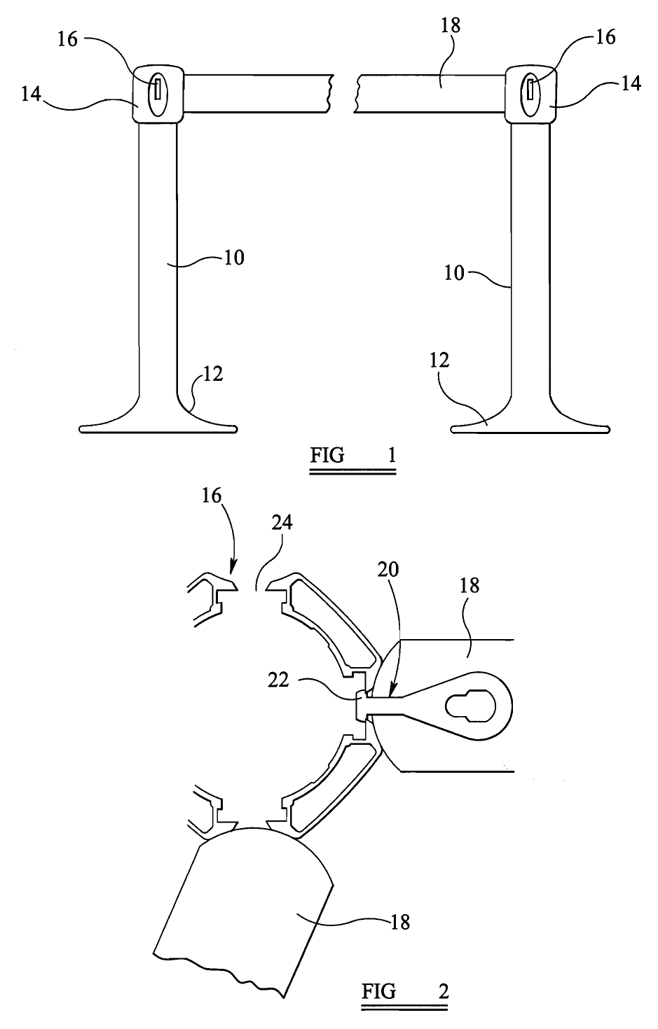

FIG. 1 is a view of part of a support system in accordance with an embodiment of the invention, the support system taking the form of a barrier system;

FIG. 2 illustrates a coupling arrangement used in the barrier system of FIG. 1;

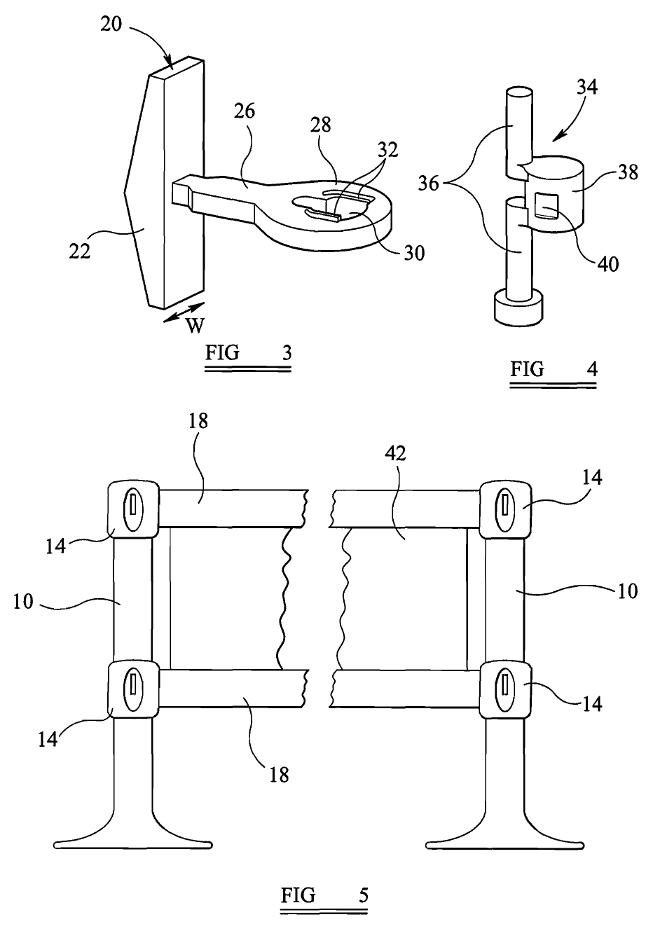

FIGS. 3 and 4 illustrate parts of the coupling arrangement;

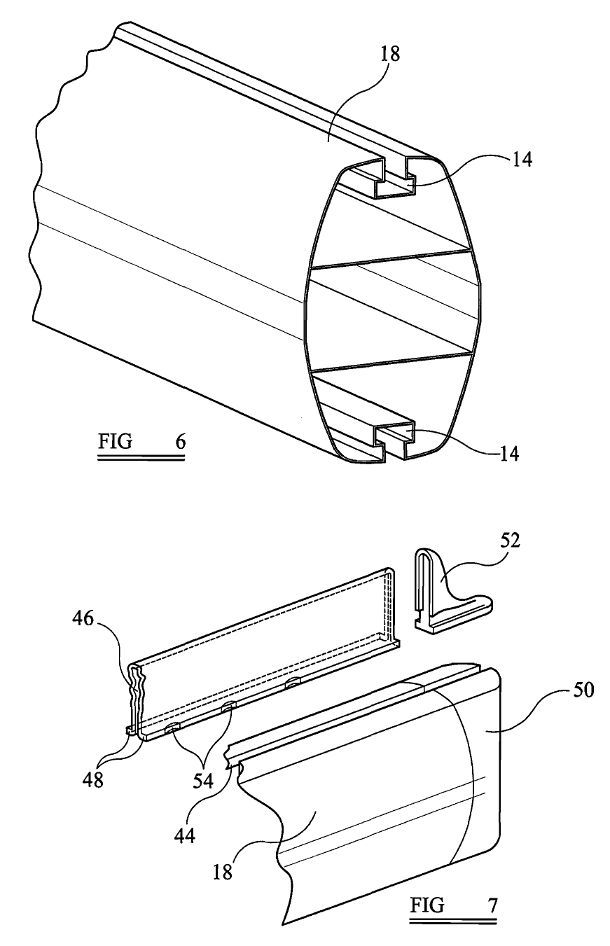

FIG. 5 illustrates an alternative support system;

FIG. 6 illustrates a barrier rail used in the arrangements of FIGS. 1 to 5;

FIG. 7 illustrates a display support assembly for use with the barrier rail of FIG. 6;

FIG. 7a illustrates an alternative display support assembly;

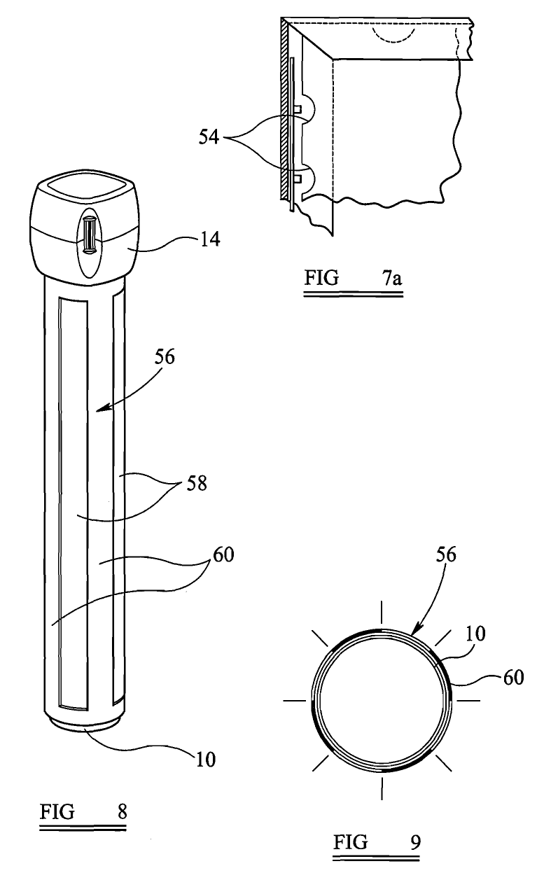

FIGS. 8 and 9 illustrate an adjustable display arrangement;

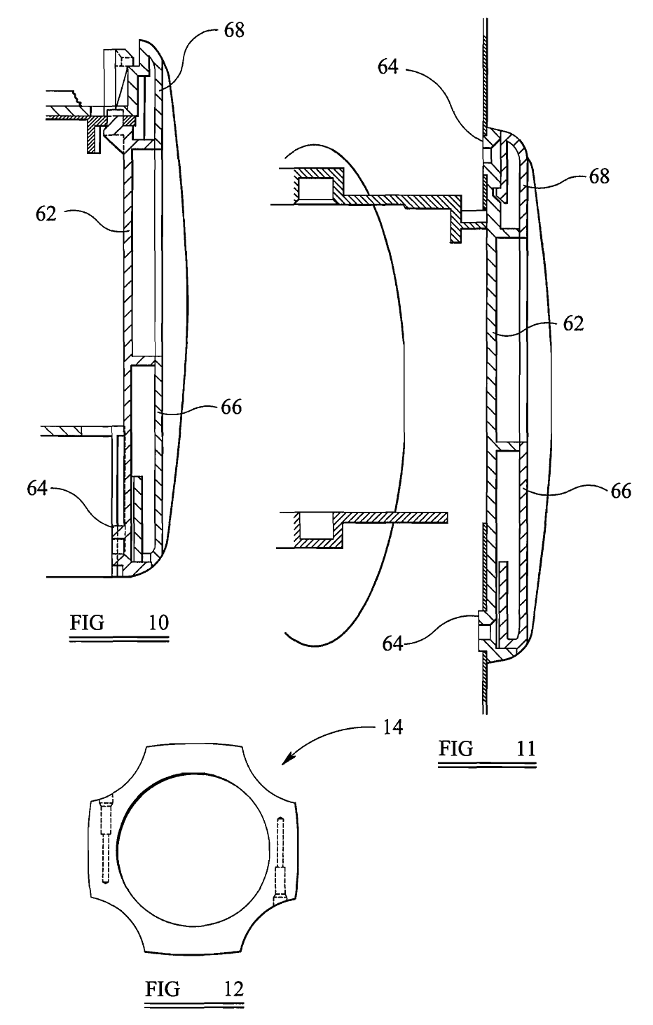

FIGS. 10 to 12 illustrate forms of housing assembly; and

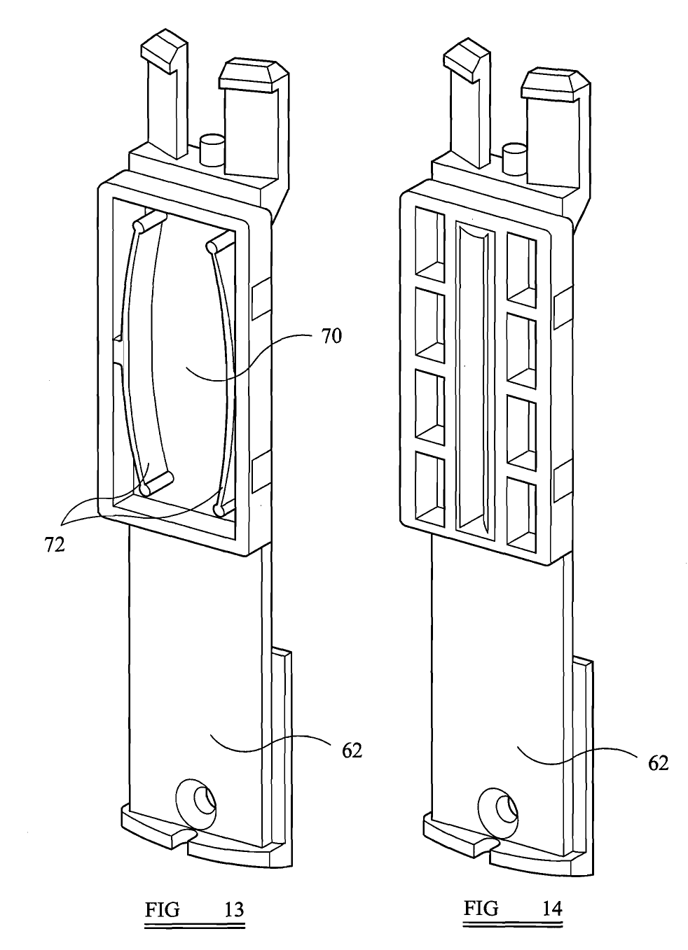

FIGS. 13 and 14 illustrate parts of the housing assembly of FIG. 10.

FIG. 1 illustrates part of a support system in the form of a barrier system comprising a pair of uprights in the form of posts 10 supported upon bases 12. The bases 12 could be integral with the posts 10 or the posts 10 could be secured thereto. Further, rather than use bases 12, the posts 10 could be received in appropriate sockets provided in the surface upon which the barrier is to be located. Each post 10 is provided at its upper end with a housing 14 in which sockets 16 are formed, by which a barrier or rail member in the form of a barrier rail 18 is secured at each end to the posts 10.

The barrier rail 18 is secured to the housings 14 mounted on the posts 10 using a coupling arrangement of the form illustrated in FIGS. 2 to 4. The coupling arrangement comprises a lock member 20 secured within an end of the barrier rail 18. The lock member 20 comprises a head 22 of width w greater than a width of a slot 24 formed in the socket 16. The width w is chosen such that with the head 22 of the lock member 20 angled or tilted relative to the socket 16, the head 22 can be passed through the slot 24, but that with the lock member 20 perpendicular to the socket 16, the head 22 can no longer fit through the slot 24 and so is retained by the socket 16.

As shown in FIG. 3, the head 22 is integrally formed with a stem 26 including an enlarged region 28 in which an opening 30 is formed. A pair of resilient arms 32 are provided adjacent the opening 30. The lock member 20 is secured to the rail 18 by means of a crank 34 including a pivot pin region 36 defining a pivot axis about which the crank 34 is rotatable, in use, and a cranked region 38 which, in use, sits within the opening 30. The cranked region 38 includes flats 40 co-operable with the arms 32 to provide a pair of detent positions in which angular movement of the crank 34 is resisted.

The crank 34 includes a head provided with formations to allow the head, and hence the crank 34 to be rotated. The formations could be such as to assist manual rotation of the crank 34. Alternatively, they could be designed to receive a tool, for example in the form of a screw driver or an Allen key.

In use, in order to secure a barrier rail 18 to a housing 14 mounted upon a post 10, the crank 34 is rotated to an angular position in which the lock member 20 protrudes from an end of the barrier rail 18. With the lock member 20 in this position, it will be appreciated that the head 22 thereof can be angularly positioned relatively to the socket 16 such as to allow the head 22 to be passed through the slot 24 of the socket 16. After insertion of the head 22 through the slot 24, the angular position of the lock member 20, and hence the head 22, can be altered so as to resist return movement of the head 22 through the slot 24. Once so positioned, rotation of the crank 34 through approximately 180° causes retraction of the lock member 20 relative to the rail 18, thus securing the rail 18 to the housing 14 mounted upon the post 10. Rotation of the crank 34 continues until a detent position is reached in which resilience of the spring arms 32 co-operating with the flats 40 formed on the crank 34 resist angular movement of the crank 34. Accordingly, release of the rail 18 from the housing 14 mounted upon the post 10 is resisted.

Once the barrier rail 18 has been secured, at one end, to one of the posts 10, the other end of the barrier rail 18 can be secured to another of the posts 10. Although FIG. 1 illustrates only a pair of posts and a single barrier rail 18, it will be appreciated that additional posts and barrier rails may be used. Further, the assembly may be used to form either linear barriers, or barriers extending in a range of other formations. Further, as illustrated in FIG. 2, the barrier rail 18 may be secured to the post 10 in a range of different angular positions, and in this regard the end of the barrier rail 18 is conveniently curved in a manner similar to the curving of the socket 16, although this is not necessarily essential to the invention.

As shown in FIG. 5, each post 10 may be designed to allow a pair, or more, of barrier rails 18 to be secured thereto at different heights. Although the invention could be used to provide a barrier with rails at two or more heights, conveniently the rails 18 are designed so as to allow, for example, display devices or other devices to be secured thereto. In the arrangement illustrated in FIG. 5, the barrier rails 18 are designed to support therebetween a panel 42. The panel 42 could take a range of forms. For example, it could take the form of a printed board, forming a display panel. Alternatively, the panel 42 could comprise an electrical or electronic device, for example in the form of a liquid crystal display screen, a plasma screen or a matrix display. It will be appreciated that a range of other alternatives are possible. For example, the panel could be adapted to have printed information secured thereto, for example using pins, or it could simply serve as a screen or partition.

As illustrated in FIG. 6, in order to accommodate the securing of a display panel 42 or other device to the rail 18, the rail 18 is conveniently provided with support grooves or slots 44. Conveniently, the support slots 44 are of re-entrant form, and FIG. 6 illustrates the case where the support slots 44 are in the form of re-entrant grooves. As described hereinbefore, the re-entrant grooves forming the support slots 44 could support devices of a range of forms, including display panels, for example in the form of printed boards, or electrical or electronic devices. Further, although FIG. 5 illustrates the case where the display panel 42 is located between a pair of barrier rails 18, this need not always be the case and a device could be supported, either beneath or above, any of the barrier rails 18, if desired. Further, additional sections of barrier rail or the like may be provided and arranged to interconnect the rails 18 to form, for example, a frame of square or rectangular form, the additional sections being secured to the rails 18 using, for example, coupling arrangements of the type described hereinbefore, or other forms of coupling arrangement. A display device may be housed within the frame so formed.

FIG. 7 illustrates an assembly to allow a display panel to be secured to a single barrier rail 18, the assembly comprising a length of a perspex or similar material folded so as to be of substantially inverted T-shaped cross-section, defining a slot 46 adapted to receive a strip of printed media. The legs 48 of the device are receivable within the re-entrant groove 44 to secure the assembly to the rail 18.

In the arrangement illustrated in FIG. 7, the rail 18 is provided with an end cap 50, and a corresponding end cap 52 is provided to prevent unauthorised access to the slot 46 and thereby prevent unauthorised removal or substitution of the printed media carried thereby. Although the arrangement illustrated in FIG. 7 shows the assembly supported above the rail 18, it will be appreciated that it may be accommodated beneath the rail 18, if desired.

Although not illustrated, the post 10 and/or the rail 18 may be provided, internally, with, for example light emitting diodes or other light emitting devices or illumination means. The devices may be provided simply to provide an indication of the location of the barrier rail 18, for example to provide a warning of the presence of the barrier in areas of low ambient light or at night. Another possibility is for the post and/or rail to be made up, at least in part, of a luminous material. Further, the light emitting devices may serve to illuminate, for example, printed media carried by the rail 18 either in the manner illustrated in FIG. 5 or using the assembly illustrated in FIG. 7. Where the assembly illustrated in FIG. 7 is used, then conveniently notches may be formed in the edges of the legs 48, the notches being located adjacent the light emitting devices such that minimal reflection of light occurs at the edges of the legs 48, thus reducing the power consumption necessary to achieve a desired level of illumination and improving the efficiency of the arrangement. The notches are therefore, conveniently, of part-circular form. This is illustrated diagrammatically in FIG. 7 by dashed lines 54. FIG. 7a illustrates, diagrammatically, a similar arrangement which could be used in the illumination of a panel carried, for example, in the manner of FIG. 5. Where electrically powered display devices or illumination means are provided, the electrical supply may be derived from the electrical mains or from batteries or other electrical storage devices. If appropriate, solar- or wind-powered generators or other form of electrical generator may be used.

FIGS. 8 and 9 illustrate the provision of a display arrangement associated with a post 10. The display arrangement comprises a sleeve 56 encircling the post 10 and being angularly movable relative thereto. The sleeve 56 is provided with apertures in the form of elongate slots 58. Between the slots 58, the sleeve 56 includes panels 60 of an opaque material. It will be appreciated that the outer surface of the post 10 is visible through the apertures 58, but that the panels 60 obscure the adjacent parts of the post 10. If the outer surface of the post 10 were provided with signage or images, it will be appreciated that parts of the signage or images would be visible through the apertures or slots 58. The parts of the signage or images beneath the panels 60 would not be visible. By appropriate angular manipulation of the sleeve 56, it will be appreciated that a selection may be made regarding which parts of the signage or images are viewable, thus it is possible to provide a display arrangement in which a change in the displayed information can be attained in a simple and convenient manner.

Although FIG. 8 illustrates the case where the sleeve 56 is simply provided with apertures 58, it will be appreciated that the apertures 56 could be closed by transparent windows, and if desired the transparent windows could have an optical effect, for example they could take the form of lenses. However, this need not always be the case.

Although FIG. 8 illustrates the case where the sleeve 56 is angularly movable to determine which part of the signage or images is visible, it will be appreciated that arrangements are also possible in which the sleeve 56 may be, for example, slid vertically to determine which parts of an image are viewed. Further, arrangements are possible where the sleeve 56 extends around only part of the post. Depending upon the design of barrier rail used, a similar form of display arrangement may be used therewith. If desired, means may be provided for resisting unauthorised adjustment of the position occupied by the sleeve. The sleeve could, if desired, be secured to, for example, part of the housing 14.

Another possibility is for the post to be provided with at least one window or aperture, and for signage or images to be provided internally of the post, the signage or images being movable relative to the post to determine which parts thereof can be viewed through the window or aperture.

The housing 14 may take a range of different forms. One particularly advantageous form is illustrated in FIG. 10. This arrangement is intended for location at the top of a post 10, but could be used elsewhere. In the arrangement shown in FIG. 10, the housing 14 comprises four connection elements 62 which are spaced apart around the periphery of the post 10. Each connection element 62 includes, adjacent its lower end, a projection 64 arranged to be received within a corresponding opening formed in the post 10. If desired, a screw threaded bolt may be arranged to pass through the projection 64 to bolt or screw the element 62 to the upper end of the post 10. However, this need not always be the case.

A lower housing member 66 of generally annular form, surrounds the lower ends of the connection elements 62 and serves to cover the parts thereof upon which the projections 64 are formed thereby preventing radially outward movement of these parts of the connection elements 62, thus preventing or restricting unauthorised removal of the projections 64 from the associated openings and, hence, the housing 14 from the post 10. A second, upper housing member 68 also of generally annular form surrounds the upper part of the connection elements 62. Conveniently the upper housing 68 is arranged to be snap-fitted into position, thus securing the upper and lower housing members 66, 68 and the connection elements, to one another and to the post. However, this need not always be the case. The arrangement illustrated in FIG. 10 may, in addition to being able to have barrier rails 18 secured thereto, also house a rotatable spool of a retractable barrier system. Further, the sockets 16 thereof may be able to receive parts of the coupling arrangements used by such retractable barrier systems, if required.

FIG. 11 illustrates an arrangement similar to that illustrated in FIG. 10 but in which the housing 14 is to be mounted part-way along the length of the post 10. As illustrated in FIG. 11, in this case both the upper and lower ends of the connection elements 62 are provided with projections 64 arranged to be received within corresponding openings formed in sections of the post 10. It will be apparent from FIG. 11 that, in this case the post 10 is not a single component, but rather is made up of separate sections. As with the arrangement illustrated in FIG. 10, the housing 14 is capable of housing a retractable barrier spool.

FIG. 12 illustrates an alternative to the arrangement of FIG. 11 for use in situations where the provision of a retractable barrier arrangement part-way along the height of a post 10 is not required. In the arrangement of FIG. 12, the housing 14 takes the form of two halves which can be clamped around the post 10 using, for example, screws or bolts.

FIGS. 13 and 14 illustrate two alternative forms of connection element 62 suitable for use in the arrangement shown in FIG. 10. The connection element illustrated in FIG. 13 is intended for use in locations in which the socket is to receive or co-operate with another component of a coupling arrangement, for example to allow a barrier rail 18 to be secured in position or to secure a coupling carried by an end part of a flexible barrier in a desired location. The connection element 62 includes an opening 70 in which, for example, the head 22 of a lock member 20 can be accommodated after having passed through a slot defined, in combination, by the upper and lower housings 66, 68. Within the opening 70 is located a pair of spring elements 72. The elements 72 could take the form of leaf springs, for example of metallic construction, but in the arrangement illustrated take the form of resilient regions formed integrally with the remainder of the connection element 62. The purpose of the spring elements 72 is to hold the head 22 of the lock member 20, or other coupling component, centrally relative to the slot 24 and to resist the lateral movement thereof which must occur in combination with tilting movement to allow the head 22 to be withdrawn from the socket. As a consequence, accidental release is resisted.

The connection element 62 illustrated in FIG. 14 is intended for use in applications in which the housing 14 houses a rotatable spool of a flexible, retractable barrier arrangement. In this case, rather than serving as a socket to which another part of a coupling arrangement can be secured, the connection element 62 serves to define a slot through which the flexible barrier material of the retractable barrier system can be retracted, in use. It is envisaged that a housing may include a single connection element of this form and one or more connection elements of the form shown in FIG. 13.

It will be appreciated that a wide range of modifications and alterations to the arrangements described hereinbefore can be made without departing from the scope of the invention. The arrangements described hereinbefore are merely examples of products falling within the scope of the invention. Further, although the description hereinbefore is of a support system in the form of a barrier system, it will be appreciated that the invention is also applicable to other forms of support system. For example, it could be used in the provision of exhibition display stands, or to provide stand alone supports for signage or advertising, or in a range of other applications, including the provision of partitions or screens.

1. A support system comprising a first component, a second component to be secured to the first component and to be supported, at least in part, thereby in use, and a coupling arrangement for securing the first and second components to one another, the coupling arrangement comprising a lock member secured to one of the first and second components by a crank, and a socket provided on the other of the first and second components and adapted to receive part of the lock member, wherein the lock member and the socket are designed such that the lock member can only be inserted into or removed from the socket when tilted or angled relative thereto.

2. A system according to claim 1, wherein one of the first and second components comprises a support.

3. A system according to claim 2, wherein the support is in the form of a post.

4. A system according to claim 2, wherein the other of the first and second components comprises one of a barrier and a rail member.

5. A system according to claim 4, wherein the said other of the first and second components is of rigid or generally rigid form.

6. A system according to claim 1, wherein one of the first and second components comprises one of a barrier and a rail member and the other comprises a component arranged substantially perpendicularly thereto.

7. A system according to claim 6, wherein a pair of barrier or rail members is provided, and together with the associated perpendicular components forms a frame.

8. A system according to claim 7, wherein the frame is of square or rectangular form.

9. A system according to claim 7, wherein the frame is adapted for use as a support.

10. A system according to claim 9, wherein the frame is adapted to support at least one of a sheet of printed media, a display panel, signage, and an electrical or electronic display device.

11. A system according to claim 10, wherein the display device comprises at least one of an LCD screen, a plasma screen or a matrix type display device.

12. A system according to claim 1, where the lock member includes a head intended to be received, in use, by the socket, the head having a width greater than a width of the socket so that, when angularly aligned with the socket the head cannot pass through part of the socket and so can be held captive thereby.

13. A system according to claim 1, and forming part of a retractable barrier system.

14. A barrier or rail member provided along at least part of the length thereof with at least one elongate slot or groove of re-entrant shape.

15. A member according to claim 14, wherein the slot is of T-shaped cross-section.

16. A member according to claim 14, wherein the slot is adapted to receive and mount to the barrier or rail member a media support device.

17. A member according to claim 14, further comprising an illumination system provided on the support device.

18. A member according to claim 17, wherein the illumination system comprises one or more LEDs provided adjacent an edge of the support device.

19. A member according to claim 14, wherein the elongate groove or slot is adapted to support at least one of a display panel, signage, and an electrical or electronic display device.

20. A member according to claim 14 and adapted for use in the system of claim 1.

21. A post and/or barrier or rail member for use as part of a barrier system and adapted to be illuminated using illumination means.

22. A post and/or barrier or rail member according to claim 21, wherein the illumination means comprises internally located light emitting devices.

23. A post and/or barrier or rail member for use as part of a barrier system and which is made up, at least in part, of a luminous material.

24. A socket for use in a barrier system and into which a lock member is insertable when tilted, the socket comprising a slot through which part of the lock member can be introduced, the said part of the lock member having a dimension greater than the corresponding dimension of the slot, and biasing means arranged to apply a lateral biasing load to the said part of the lock member, when located within the socket.

25. A socket according to claim 24, wherein the biasing means comprises a leaf spring.

26. A socket according to claim 24, wherein the biasing means comprises a resilient plastics element moulded integrally with at least part of the socket.

27. A socket according to claim 24, wherein the lock member comprises a catch of a retractable barrier

28. A housing assembly for use in a barrier system and for securing to a support comprising a plurality of connection elements each having a formation associated therewith to engage, in use, a corresponding formation associated with the support, a lower housing member adapted to overlie and cover part of each connection element to restrict outward movement thereof, and an upper housing member adapted to overlie and cover part of each connection element, the upper housing member preferably being snap-fitted to the connection elements to secure the connection elements and upper and lower housing members to one another and to the support.

29. An assembly according to claim 28, wherein the support comprises at least one of a tubular post or post section, an adapter to allow the housing assembly to be fitted to another component, and means for mounting the housing assembly to another structure.

30. An assembly according to claim 28, wherein an upper part of each connection element is provided with a formation engageable with a second support.

31. An assembly according to claim 28, wherein the housing assembly defines at least one socket.

32. An assembly according to claim 28, wherein the housing assembly houses a rotatable spool of a retractable barrier system.

33. An assembly according to claim 28, wherein at least one of the connection elements is provided with a pocket or opening forming part of a socket.

34. An assembly according to claim 31, further comprising biasing means associated with the socket.

35. A post for use in a barrier system and provided with a moveable screen shielding part of the post.

36. A post according to claim 35, wherein the screen comprises an apertured sleeve mounted on the post, the position of the sleeve being adjustable to expose different parts of the post through the apertures of the sleeve.

37. A post according to claim 36, wherein the apertures of the sleeve are provided with transparent elements.

38. A post according to claim 37, wherein the transparent elements incorporate lenses or the like.

39. A post according to claim 35, wherein the screen is adapted for angular movement to switch between a first set of images being displayed and a second set being displayed.

40. A post for use in a barrier system and having at least one window or aperture formed therein, movable internal signage or images being provided within the post, movement of the signage or images changing the image viewable through the window(s)/aperture(s).
